(19) United States
(12) Patent Application Publication
(10) Pub. No.: US 2014/0166824 A1
(43) Pub. Date: Jun. 19, 2014

(54) Adjustable Support

(71) Applicant: CONCRETE ALTERNATIVES & MORE, INC., Drums, PA (US)

(72) Inventor: Robert G. Tarapchak, Drums, PA (US)

(73) Assignee: Concrete Alternatives & More, Inc., Drums, PA (US)

(21) Appl. No.: 13/861,489

(22) Filed: Apr. 12, 2013

Related U.S. Application Data
(60) Provisional application No. 61/737,918, filed on Dec. 17, 2012.

(51) Int. Cl. F16L 3/12; F16M 13/02

(52) U.S. Cl. CPC F16L 3/1222; F16M 13/022
USPC 248/49; 248/125.2

(57) ABSTRACT

An adjustable support may have one or more screw piles at its base. The bottom side of a bottom plate may be welded to the screw pile. A top plate may be positioned on top of the bottom plate. A threaded stud is then placed over a nut/bushing affixed to the top side of the top plate and threaded into and through the nut/bushing.

### CROSS-REFERENCE TO RELATED APPLICATIONS

This application claims priority under 35 U.S.C. §119(e)(1) from U.S. Provisional Patent Application No. 61/737,918, filed on Dec. 17, 2012, for “Adjustable Pipe Support,” the disclosure of which is incorporated herein by reference.

### STATEMENT REGARDING FEDERALLY SPONSORED RESEARCH

Not Applicable.

### BACKGROUND

1. Field of Invention

The present invention relates to apparatus and systems used to support industrial loads, such as those found at drilling sites.

2. Description of Related Art

Industrial loads (e.g., pipes) have long been supported by various means. U.S. Pat. No. 2,684,222 discloses an adjustable support that comprises a base plate or concrete block to hold the support in place. Similar examples of supports, such as those disclosed in U.S. Pat. Nos. 5,110,073 and 4,445,656, use bases that sit on or are clamped to the surface on which the support will stand.

The problem inherent with known supports is the lack of vertical and lateral stability they provide whenever the industrial load to be supported is placed thereon. For example, concrete is known to settle, and a support base set in concrete will therefore move along with the concrete as it settles. With respect to supports comprised of bases that sit upon the surface, any disturbance of that surface will cause the support to move. Another problem inherent with known supports is the difficulty encountered when adjusting them. For example, the support disclosed in U.S. Pat. No. 2,684,222 comprises a bottom nut positioned within that support's I-beam which makes it difficult to adjust that nut (i.e., it is difficult to position a wrench within the confines of the I-beam to turn the nut). There is accordingly a need for a support apparatus that is easily adjustable and stable when in place supporting an industrial load.

### SUMMARY

The present invention is an adjustable support that is comprised of one or more screw piles at its base. Screw piles are well known in the art. Generally, a screw pile consists of an open-ended tubular shaft having one or more helixes externally mounted thereon adjacent to its pointed lower end. The shaft typically comprises a bottom anchor section carrying the helixes and one or more extension sections. The shaft has means, such as pin holes, at its upper end, for insertion of locking pins to connect the shaft with a drive head assembly which functions to rotate the pile into the ground

In one embodiment of the present invention, the top of a screw pile is slid into a sleeve that has been welded onto a circular bottom plate. The bottom plate is comprised of a center hole and a plurality of ring holes that surround the center hole. A circular top plate is positioned on top of the bottom plate. The top plate is comprised of the same center and ring holes as the bottom plate, as well as a nut/bushing that is welded onto the top plate's top surface and fit into the center hole. The top plate is positioned on top of the bottom plate in such a way as to align the center holes of each plate. A threaded stud is then placed over the nut/bushing of the top plate and threaded into the nut/bushing. Once assembled, the screw pile is rotationally driven into the ground at the desired location. In preferred embodiments of the invention, fixtures such as a saddle clamp capable of holding a section of industrial pipe is attached to the top of the threaded stud. When set in place, the saddle clamp is opened and the pipe to be supported is laid into the clamp. When the pipe is in position, the clamp is closed and bolted.

In an alternative embodiment of the present invention, two screw piles are driven into the ground in locations perpendicular to the object to be supported with an I-beam placed on top of the two screw piles. A bottom place is then mounted to the I-beam by attached a mounting place to the bottom of the sleeve. Alternatively, two sets of top and bottom plates may be used with a set mounted to each of the two screw piles, and the threaded stud then attached to the base of the I-beam and the object to be supported attached to directly to the top flange of the I-beam by any known means of attachment.

In alternative embodiments used in tension-support applications, the screw pile is driven into the ground at an angle. The threaded stud is then attached to a support element such as a cable and wound into the nut/bushing of the top plate. A tension plate is then added to the invention that is affixed to threaded stud below the bottom plate and housed within the sleeve.

### BRIEF DESCRIPTION OF THE DRAWINGS

FIG. 1 is a side view of an adjustable pipe support consistent with the present invention.

FIG. 2 is a top view of a top plate consistent with the present invention.

FIG. 3 is a bottom view of a bottom plate consistent with the present invention.

FIG. 4 is a perspective view of an alternative embodiment of the present invention.

FIG. 5 is a perspective view of an alternative embodiment of the present invention.

### DETAILED DESCRIPTION

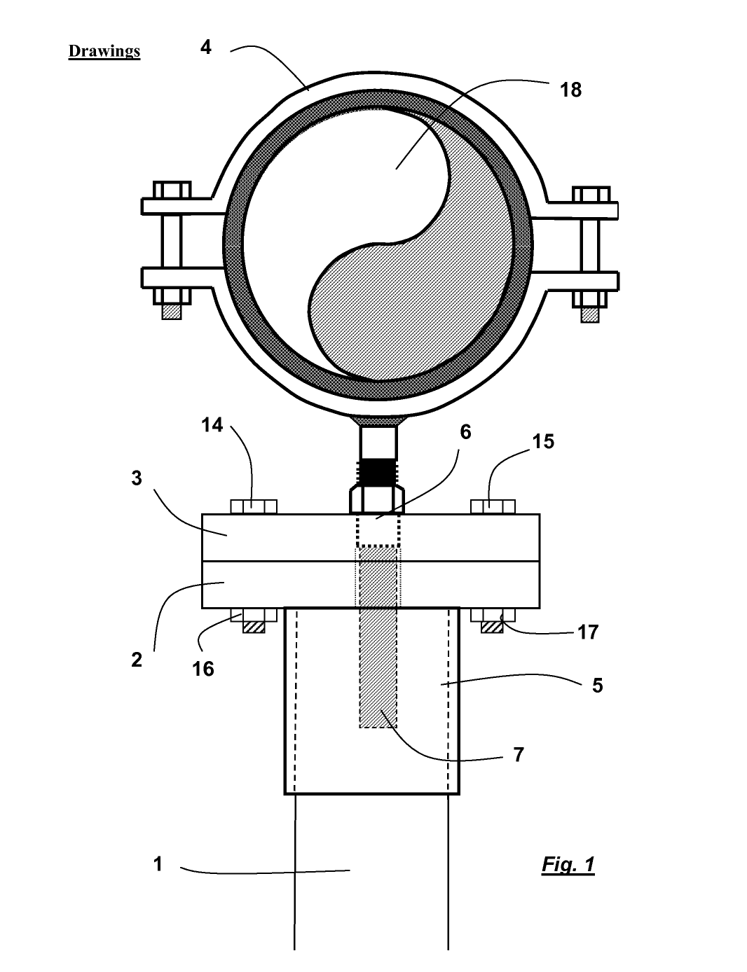

Referring to FIG. 1, an embodiment of an adjustable support consistent with the present invention is shown. The embodiment is comprised of a screw pile 1, a bottom plate 2, a top plate 3, and a threaded stud 7. The top of the screw pile 1 is slipped into a sleeve 5 that is welded or bolted to the bottom side of the bottom plate 2 and until the top of the screw pile 1 abuts the bottom side of the bottom plate 3 as shown in FIG. 1. The top plate 3 is positioned on top of the bottom plate 2. The top plate 3 is comprised of a hole running through its center. The bottom portion of a machined nut/bushing 6 is slipped into the hole and the nut/bushing 6 is then welded to the top side of the top plate 3. The nut/bushing 6 is created by machining the bottom half of a threaded nut into a flanged bushing so that the bushing end slips into the center hole of the top plate 3 until the flange of the bushing abuts the top side of the top plate 3. The threaded stud 7 is then wound through the inner threads of the nut/bushing 6, and passes through the top plate 3, the bottom plate 2, and the screw pile 1 as shown in FIG. 1. A standard locking nut (not shown in the figures) may be threaded down from the top of the threaded stud 7 adjacent to the nut-bushing 6 to secure the threaded stud 7 in the nut/bushing 6 once the threaded stud 7 is wound into place. In the embodiment shown in FIG. 1, a saddle clamp cable of holding a section of pipe 18 is affixed to the top of the threaded stud 7. In alternative embodiments, fixtures such as pipe cradles, flange cradles, flange mounts, and flat mount plats are affixed to the top of the threaded stud 7.

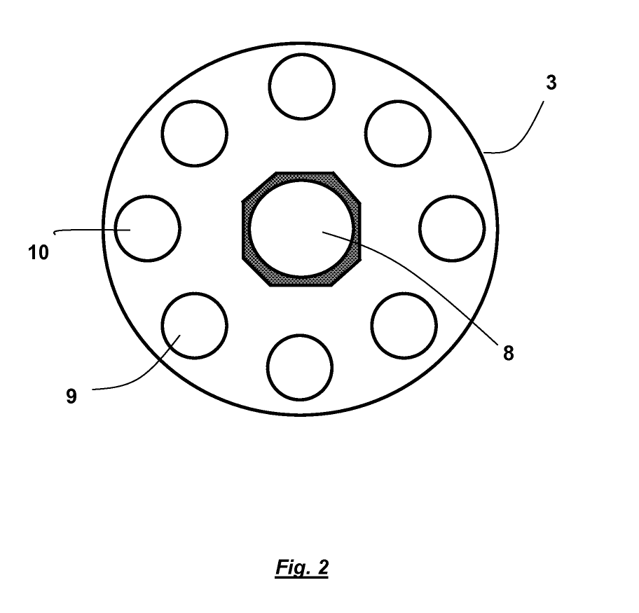

FIG. 2 illustrates the configuration of a top plate 3 consistent with the present invention. The top plate 3 can be made of any solid material, but is preferably made of steel. The top plate 3 is comprised of a center hole 8 and a plurality of ring holes 9, 10 drilled through the depth of the top plate 3. On the top surface of the top plate 3, and aligned with the center hole 8, the bottom portion of the nut/bushing 6 is slipped into the center hole 8 and permanently attached to the top side of the top plate 3 (e.g., via welding).

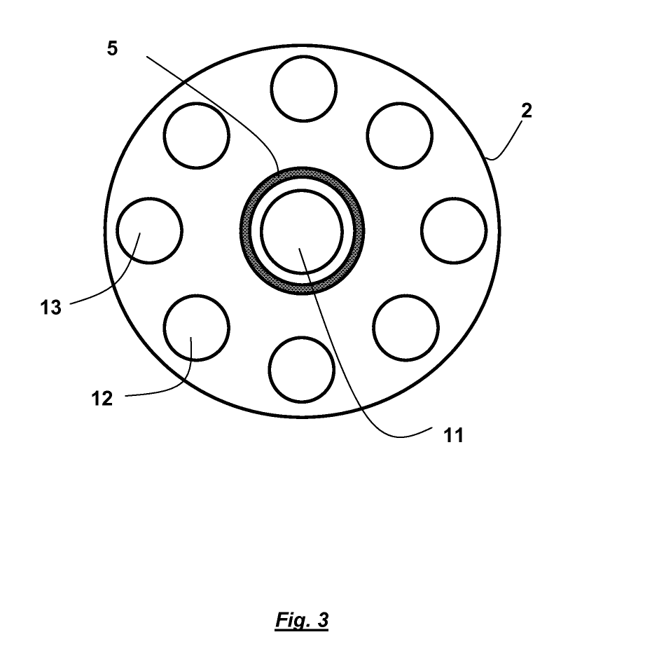

FIG. 3 illustrates the configuration of a bottom plate 2 consistent with the present invention. The bottom plate 2 can be made of any solid material, but is preferably made of steel. Identical in size to the top plate 3, the bottom plate 2 is comprised of a center hole 11 and a plurality of ring holes 12, 13 drilled through the depth of the bottom plate 2. A sleeve 5 is attached (e.g., via welding) to the bottom side of the bottom plate 2 as shown in FIG. 3.

Referring back to FIG. 1, to adjust the height of the fixture being held by the threaded stud 7 (which in the case of FIG. 1, is a saddle clamp 4 for a section of pipe), a user attaches a tool such as a wrench to the nut/bushing 6 and turns the nut/bushing 6 together with the top plate 3, which causes the threaded stud 7 to rise or fall as the internal threads of the nut-bushing 6 turn. Once the desired height of the threaded stud 7 is attained, the user aligns the ring holes of both the top 3 and bottom plates 2 and places one or more flange bolts 14, 15 through the corresponding ring holes of both plates and tightens them with standard nuts 16, 17. This holds the thread stud 7—and by extension, the fixture attached to the top of the threaded stud 7—at the desired height.

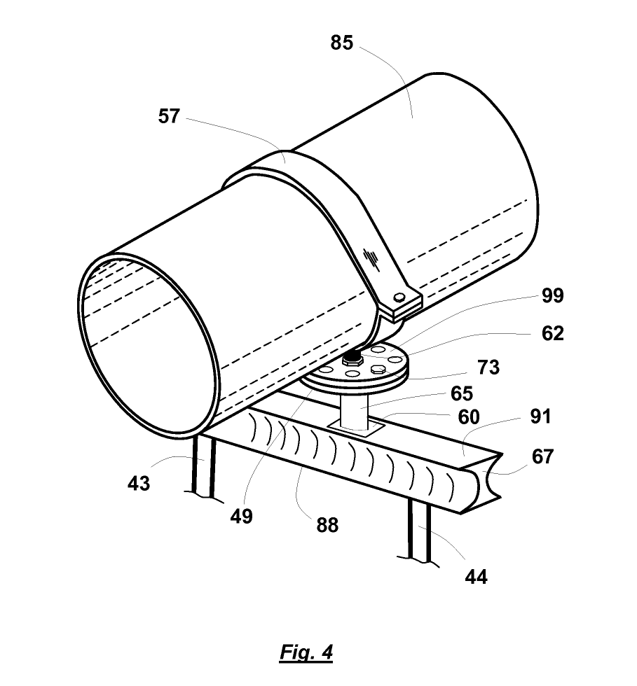

FIG. 4 illustrates an alternative embodiment of the present invention wherein more than one screw pile (43, 44) is attached to the bottom flange 88 of an I-beam 67. The screw piles (43, 44) can be welded or bolted to the bottom flange 88 of the I-beam 67, but any permanent means of attachment can be used. The top edge of a sleeve 65 is affixed to the bottom plate 49 as was explained in the description of FIG. 3 above, and the sleeve's 65 bottom edge is affixed to a mounting plate 60. The mounting plate 60 is affixed to the top flange 91 of the I-beam 67, as shown in FIG. 4, by any known means of attachment such as welding. The threaded stud 62 is then threaded through the nut/bushing 61 affixed to the top plate 99. As shown in the embodiment illustrated in FIG. 4, a saddle clamp 57 may then be affixed to the top of the threaded stud 62 and the user can adjust the height of the saddle clamp 57 by turning the top plate 99 as described above and then placing one or more flange bolts 73 through the top plate 99 and bottom plate 49 to hold the saddle clamp 57 at its desired height. The saddle clamp 57 may then accept the pipe 85 to be supported, which is held in place when the saddle clamp 57 is closed as shown in FIG. 4. As mentioned above, alternative fixtures may be attached to the top of the threaded stud 62 to create different embodiments of the present invention.

In an alternative embodiment of the invention not shown in the figures, two sets of top and bottom plates may be affixed to the top of each of the screw piles as described above, with the threaded studs of each set affixed to the bottom flange of the I-beam. the load to be supported in then attached to the top flange of the I-beam using any known means of attached. In another alternative embodiment known shown in the figures, a mounting plate may be affixed to the top of a concrete pillar or similar compression structure with the bottom edge of the sleeve attached to the mounting as shown and described in FIG. 4.

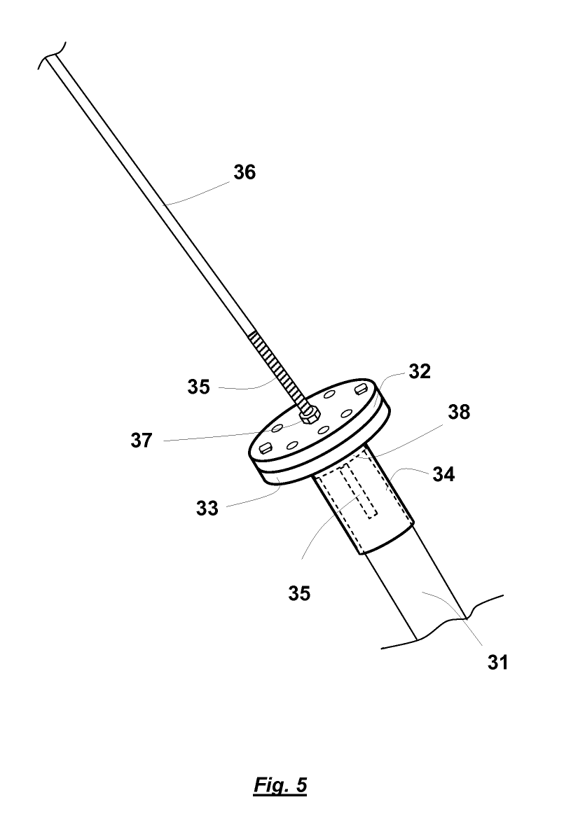

FIG. 5 illustrates another alternative embodiment of the present invention used in tension-support applications. In this embodiment, the screw pile 31 is driven into the ground at a angle. The top plate 32, bottom plate 33, and sleeve 34 are place onto the screw pile 31 by sliding the sleeve 34 over the screw pile 31. The threaded stud 35 is attached to a cable 36 by any known means of attachment (e.g., a loop). The threaded stud 35 is then wound into the nut/bushing 37 affixed to the top plate 32. In the embodiment shown in FIG. 5, a tension plate 38 is added. The tension plate 38 is comprised of a steel plate with a threaded central hole. The tension plate 38 has a circumference that allows it to fit inside the sleeve 34 and abut the bottom side of the bottom plate 33. In the embodiment shown in FIG. 5, the threaded stud 35 is wound through the threaded central hole of the tension plate 38. This provides tension support against the force applied by the cable 36. The cable 36 attached to the threaded stud 35 can be used to support a vertically-oriented structure such as a tower or mast, essentially creating a screw anchor for the structure that can be tightened or loosened by turning the top plate 32 about the bottom plate 33 as is explained above.

While the invention has been described in conjunction with specific embodiments thereof it is evident that many alternatives, modifications and variations will be apparent to those skilled in the art. Accordingly, the preferred embodiments of the invention, as set forth herein, are intended to be illustrative, not limiting. Various changes may be made without departing from the true spirit and full scope of the invention, as defined in the following claims.

What is claimed is:

1. An adjustable support comprising:
(a) at least one screw pile;
(b) a bottom plate, said bottom plate comprising a plurality of holes and a sleeve dimensioned to slip onto the top of said screw pile;
(c) a top plate, said top plate comprising a plurality of holes and a nut/bushing attached to the top side of said top plate; and
(d) a threaded stud

2. The adjustable support of claim 1, further comprising a saddle clamp.

3. The adjustable support of claim 1, further comprising a pipe cradle.

4. The adjustable support of claim 1, further comprising a flange cradle.

5. The adjustable support of claim 1, further comprising a flange mount.

6. The adjustable support of claim 1, further comprising an I-beam.

7. The adjustable support of claim 6, wherein the number of screw piles is at least two.

8. The adjustable support of claim 1, further comprising a tension plate.

9. The adjustable support of claim 1, further comprising a mounting plate.

10. An adjustable pipe support comprising:
(a) at least one compression structure;
(b) a mounting plate
(c) a bottom plate, said bottom plate comprising a plurality of holes and a sleeve dimensioned to slip onto the top of said screw pile;
(d) a top plate, said top plate comprising a plurality of holes and a nut/bushing attached to the top side of said top plate; and
(e) a threaded stud
